(19) United States
(12) Patent Application Publication
(10) Pub. No.: US 2022/0198912 A1
(43) Pub. Date: Jun. 23, 2022

(54) SYSTEM FOR MANAGING A PLURALITY OF ALARMED INDIVIDUAL SPACES

(71) Applicant: PROPHILTECH, Caen (FR)

(72) Inventor: Philippe LANDAUD, Caen (FR)

(21) Appl. No.: 17/604,599

(22) PCT Filed: Apr. 19, 2019
(86) PCT No.: PCT/FR2019/050940

§ 371 Date: Oct. 18, 2021

(51) Int. Cl. G08B 25/00; G08B 25/14

(52) U.S. Cl. CPC G08B 25/008; G08B 25/10; G08B 25/14

(57) ABSTRACT

The present invention relates to a system for managing a plurality of alarmed individual spaces, including: a set of detection points associated with the alarms, each detection point equipping one of the individual spaces; at least one alarm centre connected to the detection points of a subset of the set of detection points; a set of access controllers, each access controller being configured to identify a user of one of the individual spaces. The system includes a user centre to which the access controllers are connected; and, for each alarmed individual space, a module for alarm disabling and enabling connected to the user centre and connected between the or one of the alarm centre(s) and the detection point equipping the individual space, each alarm disabling or enabling module being configured to selectively disable and enable the detection point to which it is connected, and to trigger this disabling following an identification of a user by the access controller associated with the individual space.

### TECHNICAL FIELD

The present invention relates to the field of the protection and securing of individual spaces. The invention relates in particular to a system for managing a plurality of alarmed individual spaces. The invention is notably applicable, without that being exclusive or limiting, to the field of the systems for managing individual storage or warehousing spaces or boxes. Such systems are generally intended for the management of buildings comprising hundreds of individual storage spaces or boxes, each of the spaces or boxes being individually alarmed. The invention is also applicable, without that being exclusive or limiting, to the field of the systems for managing alarmed individual private lockers or emergency exits.

The invention relates also to a method for disabling the alarm of an alarmed individual space, and a computer program product for implementing this method.

### STATE OF THE ART

Centralized individual space management systems are known. Such a centralized management system is for example described in the patent document US 2017/0243416 A1. The system described in this document is intended for the management of a building comprising several individual zones or rooms. The individual zones can for example be lockers of a sport hall, or even individual rooms of a hotel. Each locker or each room is provided with an electronic lock and an access controller allowing the lock to be unlocked by an individual access card. The set of the electronic locks and access controllers is managed centrally, via a dedicated management center. Such a center can thus generate and parameterize access information intended for the access cards.

Furthermore, in the field of the protection of individual spaces of the type of alarmed individual warehousing spaces, there is a need to be able to automatically disarm the alarm of one of the individual spaces without in any way disarming the alarms of the other individual spaces managed by the same network. This need is all the more critical when such individual spaces, such as boxes or safes, are generally assigned by name to the general public and/or to particular companies, so a flexible and individualized management of the arming and the disarming of the alarms is therefore required.

On conventional systems of moderate size, typically of the order of ten or so individual alarmed spaces to be managed, known solutions make it possible to address this need by allowing an individual and decorrelated arming and disarming of the alarms. However, these systems known from the prior art do not allow for such management in the case of a greater number of individual spaces to be managed, typically of the order of a hundred or more individual spaces. This limitation results directly from the intrinsic hardware limitations of such systems, which generally make it possible to manage at the very most only eight or even sixteen distinct armings and disarmings. Now, in the field of the systems for managing individual storage or warehousing spaces, the number of individual spaces to be managed typically runs into the hundreds. Such systems from the prior art then prove totally inoperative and ineffective for the management of the alarms relating to such a number of individual spaces.

### SUMMARY OF THE INVENTION

The aim of the invention is therefore to provide a system for managing a plurality of alarmed individual spaces, that allows for a flexible, individualized and automatic management of the arming and the disarming of each alarm without affecting the other alarms of the system, and do so without structural limitation from the point of view of the number of alarms that can be managed.

To this end, the invention relates to a system for managing a plurality of alarmed individual spaces, the system comprising:
a set of detection points associated with the alarms, each detection point equipping one of the individual spaces;
at least one alarm center dedicated to the detection points, the or each alarm center being linked to the detection points of a subset of said set of detection points, for the management of said detection points;
a set of access controllers, each access controller being associated with one of the individual spaces and being configured to identify a user of said space;
   wherein the system comprises a user center to which said access controllers are connected; and the system further comprises, for each alarmed individual space, an alarm disabling and re-enabling module linked to the user center and connected between the or one of the alarm center(s) and the detection point equipping said individual space, each alarm disabling and re-enabling module being configured to selectively disable and re-enable the detection point to which it is linked, and to trigger the disabling of said detection point following an identification of a user by the access controller associated with said individual space.

By virtue of the combined presence of a user center linked to the different access controllers, and of alarm disabling and re-enabling modules linked to the user center, to the alarm centers and to the different detection points, the system according to the invention allows for a flexible and individualized management of the arming and disarming of each alarm without affecting the other alarms of the system. Furthermore, such a configuration offers the advantage of not structurally limiting the number of alarms assigned to individual spaces and that can be managed by the system. This is particularly advantageous in contexts or areas where a large number of alarmed individual spaces are to be managed, such as, for example, individual storage or warehousing spaces, or even that of the management of individual private safes.

Each alarm disabling and re-enabling module is further configured to selectively disable and re-enable the detection point to which it is linked, and to trigger the disabling of this detection point following an identification of a user by the access controller associated with the individual space. This makes it possible, through an individual identification of the user via the access controller, to temporarily disable the detection point associated with the alarm of the personal space. In fact, each detection point is permanently in service, and the user of an individual space can temporarily disable the associated detection point, via a personal identification means compatible with the access controller.

According to a first embodiment of the invention, each alarm disabling and re-enabling module consists of an electrical or electronic circuit.

According to a second embodiment of the invention, each alarm disabling and re-enabling module comprises memory means and data processing means linked to the memory means, the memory means storing an application comprising program instructions, the data processing means being configured to execute the program instructions of the application.

To this end, the invention relates also to a method for disabling the alarm of an alarmed individual space, implemented by one of the alarm disabling and re-enabling modules of the system as described above, the method comprising an initial step of reception of an alarm disabling triggering signal from the user center, following an identification of a user by the access controller associated with the individual space corresponding to the module; and a step of disabling of the detection point to which the module is linked.

Advantageously, during the initial step of reception of an alarm disabling triggering signal, a predefined timer datum accompanies the signal and is transmitted to said alarm disabling and re-enabling module by the user center; and the step of disabling of the detection point to which the module is linked lasts for at least the predefined timer time. That makes it possible, at the end of the predefined timer, to automatically return the detection point associated with the alarm of the personal space to service.

According to a particular technical feature of the invention, the duration of the predefined timer is between 0 and 255 minutes.

Advantageously, the method further comprises a step of reception by the module of a signal confirming closure of the individual space corresponding to the module, which signal is sent from the user center; and the method further comprises a step of re-enabling of the detection point to which the module is linked, said re-enabling step being performed when the predefined timer has elapsed and the confirmation signal is received. Such a step makes it possible to monitor the correct closure of the detection point to which the module is linked, before re-enabling the detection point and thus returning the alarm of the individual space to service. This thus makes it possible to increase the reliability and the responsiveness of the system.

To this end, the invention relates also to a computer program product saved on a computer-readable medium and/or that can be executed by data processing means, and comprising program instructions adapted to implement the steps of the alarm disabling method as described above, when the program product is executed on a computer or by the data processing means of one of the alarm disabling and re-enabling modules of the system as described above.

### BRIEF DESCRIPTION OF THE FIGURES

The aims, advantages and features of the management system according to the invention will become more apparent from the following description based on at least one nonlimiting implementation illustrated by the drawings in which:

FIG. 1 is a schematic representation of a system for managing multiple alarmed individual spaces according to the invention, the system comprising several alarm disabling and re-enabling modules; and

FIG. 2 is a schematic representation of one of the alarm disabling and re-enabling modules, according to a particular embodiment of the invention.

### DETAILED DESCRIPTION OF THE INVENTION

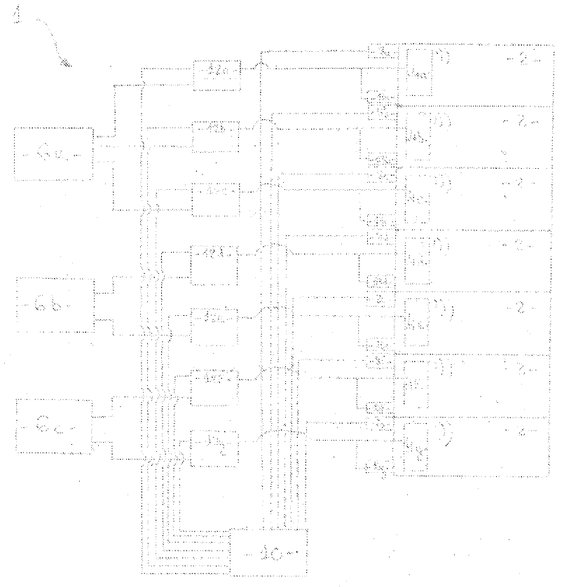

FIG. 1 represents a system 1 for managing several alarmed individual spaces 2. In the particular exemplary embodiment illustrated in FIG. 1, seven individual spaces 2 are managed by the system 1. Such individual spaces 2 can be, for example, without that being limiting within the context of the present invention, individual storage or warehousing spaces of box type, individual private safes, or even emergency exits, that are alarmed. Each user of the system 1 can access, for example via an individual identification means such as an access controller 8a-8g, one of the individual spaces 2, and only that space 2.

The system 1 comprises a set of detection points 4a-4g, at least one alarm center 6a-6c dedicated to the detection points 4a-4g, a set of access controllers 8a-8g, and a user center 10. The system 1 also comprises, for each alarmed individual space 2, an alarm disabling and re-enabling module 12a-12g. Preferably, the system 1 also comprises, for each alarmed individual space 2, a display means 13a-13g of light indicator type. In the particular exemplary embodiment illustrated in FIG. 1, the system 1 comprises seven detection points 4a-4g, three alarm centers 6a-6c, seven access controllers 8a-8g, seven alarm disabling and re-enabling modules 12a-12g, and seven display means 13a-13g.

Each detection point 4a-4g equips one of the individual spaces 2, to alarm that space 2. Each detection point 4a-4g comprises, for example, without that being limiting within the context of the present invention, one or more of the following elements taken alone or in combination: an intrusion detector of infrared motion detector type or break-glass detector type, a smoke detector or even a temperature detector.

The or each alarm center 6a-6c is linked to the detection points of a subset of the set of detection points 4a-4g. For example, in the illustrative example of FIG. 1, a first alarm center 6a is linked to three first detection points 4a-4c, a second alarm center 6b is linked to two other detection points 4d-4e, and a third alarm center 6c is linked to the other two detection points 4f-4g. Each alarm center 6a-6c is thus dedicated to the management of a subset of the detection points 4a-4g. It should be noted that, in the case of a system 1 managing a small number of alarmed individual spaces 2, the system 1 comprises only a single alarm center, the latter then being linked to all of the detection points.

Each alarm center 6a-6c is permanently in service, that is to say that the individual space or spaces 2 associated with a given alarm center 6a-6c are alarmed. In addition to the detection points that it manages, each alarm center 6a-6c can be linked also to external equipment, such as, for example, controllers of remote control or keypad type, electrical devices managed by home automation, alarm sirens, communication devices of telephone or data transmitter type, computers, and wired or wireless networks such as a wired local area network or an Internet network. Such elements, which in no way constitute an exhaustive list, are not represented in the figures for reasons of clarity. Each alarm center 6a-6c is thus configured to receive information from the detection points that it manages, and from any controllers to manually start up or switch off an alarm. Each alarm center 6a-6c is also configured to transmit data to different external equipment.

Each access controller 8a-8g is associated with one of the individual spaces 2 and is configured to identify a user of that space 2. Each access controller 8a-8g is connected to the user center 10. Each access controller 8a-8g can further be linked to a device for unlocking the individual space 2 with which it is associated, such a device not being represented in the figures for reasons of clarity. Each access controller 8a-8g can for example be an individual chip card reader, or even a magnetic contact-based individual badge reader, without that being limiting within the context of the present invention.

The user center 10 manages the alarm disablings and re-enablings for all of the detection points 4a-4g. For that, the user center 10 stores, for example, a mapping list mapping the identifiers associated with the access controllers 8a-8g and identifiers of users authorized to use the individual spaces 2 associated with the access controllers. The user center 10 is further configured to generate alarm disabling triggering signals, and signals confirming closure of an individual space, intended for the alarm disabling and re-enabling modules 12a-12g.

Each alarm disabling and re-enabling module 12a-12g is linked to the user center 10, and is connected between the detection point 4a-4g equipping the individual space 2 with which it is associated on the one hand, and the alarm center 6a-6c dedicated to this detection point on the other hand. Each module 12a-12g is configured to selectively disable and re-enable the detection point 4a-4g to which it is linked. Each module 12a-12g is further configured to trigger the disabling of its detection point 4a-4g following an identification of a user by the access controller 8a-8g associated with the corresponding individual space 2. Each module 12a-12g can also be configured to trigger the re-enabling of its detection point 4a-4g when a predefined timer has elapsed, which timer is known to the module 12a-12g following the reception of a timer datum transmitted by the user center 10.

According to a first embodiment entered in FIG. 1, each alarm disabling and re-enabling module 12a-12g consists of an electrical or electronic circuit.

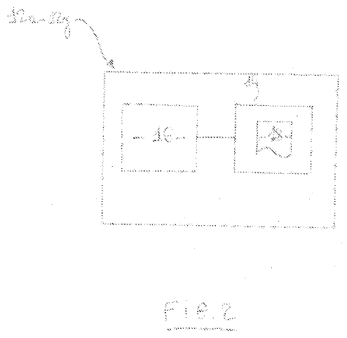

According to a second embodiment represented in FIG. 2, each alarm disabling and re-enabling module 12a-12g comprises memory means 14 and data processing means 16 linked to the memory means 14. The memory means 14 store an application 18 comprising program instructions. The processing means 16 are configured to execute the application 18. The processing means 16 for example take the form of one or more processors, dedicated to each module 12a-12g or shared between the modules 12a-12g. The application 18, when executed by the processing means 16, is capable of implementing the alarm disabling method which will be described hereinbelow.

As a variant, the alarm disabling and re-enabling modules 12a-12g can be produced directly in the form of functionalities implemented by software components, the latter being implemented on independent infrastructures or sharing one and the same hardware infrastructure. According to this variant, the software components constituting the modules 12a-12g are, for example, implemented in memory means of one or more server computers.

Each display means 13a-13g of light indicator type, which equips one of the individual spaces 2, is linked to one of the alarm disabling and re-enabling modules 12a-12g. Each alarm disabling and re-enabling module 12a-12g is, for example, configured to trigger the switching on of a display means 13a-13g, typically in the form of a colored light signal, simultaneously with the disabling of its detection point 4a-4g. Each alarm disabling and re-enabling module 12a-12g is further configured to switch off the corresponding display means 13a-13g, after the predefined timer has elapsed and after having received a signal confirming closure of the associated individual space 2.

In the particular exemplary embodiment represented in FIG. 1, the data links between the different elements are produced in the form of wired links. As a variant, the various data links can naturally be produced in any other known manner, such as, for example, in the form of wireless links of radio link type.

The method for disabling the alarm of an individual space 2 according to the invention, implemented by one of the alarm disabling and re-enabling modules 12a-12g of the management system 1, will now be described. For convenience of description, it will be assumed hereinbelow that the module 12a implements the alarm disabling method according to the invention. It should however be noted that each of the modules 12a-12g is able to implement this alarm disabling method.

It is assumed that, initially, a user of the individual space 2 associated with the module 12a identifies himself or herself with the access controller 8a corresponding to this space. It is also assumed that, following this identification of the user by the access controller 8a, the user center 10 checks the conformity of the identity of the user and, if this check is positive, generates an alarm disabling triggering signal for this individual space.

The method comprises an initial step during which the module 12a receives the alarm disabling triggering signal from the user center 10. Preferably, during this initial step, a predefined timer datum accompanies the signal and is transmitted to the module 12a by the user center 10. The duration of the predefined timer is typically between 0 and 255 minutes. This duration can be adjustable and pre-parameterized in the user center 10 for example.

The method comprises a next step during which the module 12a disables the detection point 4a to which it is linked, thus provoking the disabling of the associated alarm. The detection point 4a is then disabled but, from the point of view of the alarm center 6a which manages it, this detection point 4a is still in service and operational. Typically, this step of disabling of the detection point 4a and of the associated alarm lasts for at least the time of the predefined timer. The user of the individual space 2 can then access this space during this period, without risking an unwanted triggering of the associated alarm. Preferably, simultaneously with the disabling of its detection point 4a, the module 12a triggers the switching on of a display means 13a, typically in the form of a colored light signal, making it possible to visually signify to the user that his or her space 2 is free to access.

Preferably, at the end of this step of disabling of the detection point 4a, and therefore when the predefined timer has elapsed, the module 12a checks whether it has received from the user center 10 a signal confirming closure of the associated individual space 2. Such a signal is for example transmitted to the user center 10 by the access controller 8a, and makes it possible to check the correct reclosing of the individual space 2 and therefore of the associated detection point 4a. If this check is positive, the module 12a re-enables the detection point 4a and the associated alarm. Otherwise, the module 12a waits to receive such a signal confirming closure of the individual space 2, before re-enabling the associated detection point 4a. The individual space 2 concerned is then once again alarmed, and the corresponding detection point 4a is returned to service entirely automatically. Preferably, simultaneously with the re-enabling of its detection point 4a, the module 12a switches off the display means 13a.

It can thus be seen that the management system according to the invention offers several advantages, including:
the system allows for a flexible, individualized and automatic management of the arming and the disarming of each alarm without affecting the other alarms of the system;
there is no limitation with respect to the number of detection points that can be managed, and therefore the number of alarms assigned to individual spaces, since the detection points are managed by one or more alarm centers;
the management of the users of the individual spaces is facilitated by the presence of a dedicated user center and of access controllers connected to the user center;
the system makes it possible to check the correct closure of each detection point and, in case of incorrect closure of a detection point, to return the associated alarm to service only after the reclosure of the detection point;
the system allows each alarm to be returned to service entirely automatically;
the system allows for an individual identification of each user of a given individual space either by code or by any other means (badge, iris recognition, etc.).

1. A system for managing a plurality of alarmed individual spaces, the system comprising:
a set of detection points associated with the alarms, each detection point equipping one of the individual spaces;
at least one alarm center dedicated to the detection points, the at least one alarm center being linked to the detection points of a subset of said set of detection points, for the management of said detection points;
a set of access controllers, each access controller being associated with one of the individual spaces and being configured to identify a user of said space;
wherein the system comprises a user center to which said access controllers are connected; and in that it further comprises, for each alarmed individual space, an alarm disabling and re-enabling module linked to the user center and connected between the or one of the alarm center(s) and the detection point equipping said individual space, each alarm disabling and re-enabling module being configured to selectively disable and re-enable the detection point to which it is linked, and to trigger the disabling of said detection point following an identification of a user by the access controller associated with said individual space.

2. The system as claimed in claim 1, wherein each alarm disabling and re-enabling module consists of an electrical or electronic circuit.

3. The system as claimed in claim 1, wherein each alarm disabling and re-enabling module comprises memory means and data processing means linked to the memory means, the memory means storing an application comprising program instructions, the data processing means being configured to execute the program instructions of the application.

4. A method for disabling the alarm of an alarmed individual space, wherein the method is implemented by one of the alarm disabling and re-enabling modules of the system as claimed in claim 1, the method comprising an initial step of reception of an alarm disabling triggering signal from the user center, following an identification of a user by the access controller associated with the individual space corresponding to the module; and a step of disabling of the detection point to which the module is linked.

5. The method as claimed in claim 4, wherein, during the initial step of reception of an alarm disabling triggering signal, a predefined timer datum accompanies the signal and is transmitted to said alarm disabling and re-enabling module by the user center, and in that the step of disabling of the detection point to which the module is linked lasts for at least the predefined timer time.

6. The method as claimed in claim 5, wherein the duration of the predefined timer is between 0 and 255 minutes.

7. The method as claimed in claim 5, wherein the method further comprises a step of reception by the module of a signal confirming closure of the individual space corresponding to the module, which signal is sent from the user center (10); and in that the method further comprises a step of re-enabling of the detection point to which the module is linked, said re-enabling step being performed when the predefined timer has elapsed and the confirmation signal is received.

8. A computer program product saved on a computer-readable medium and/or that can be executed by data processing means, and comprising program instructions adapted to implement the steps of the alarm disabling method as claimed in claim 4, when the program product is executed on a computer or by a data processing means of one of the alarm disabling and re-enabling modules of the system.
